(19) United States
(12) Patent Application Publication
(10) Pub. No.: US 2022/0157304 A1
(43) Pub. Date: May 19, 2022

(54) INTERACTION DEVICE

(71) Applicant: BSH HAUSGERÄTE GMBH, München (DE)

(72) Inventors: Frank Schaefer, Puchheim (DE); Philipp Kleinlein, Muenchen (DE); Markus Helminger, Bergen (DE); Gerald Horst, Karlsruhe (DE)

(21) Appl. No.: 17/440,296

(22) PCT Filed: Apr. 2, 2020
(86) PCT No.: PCT/EP2020/059361

§ 371 Date: Sep. 17, 2021

(30) Foreign Application Priority Data
Apr. 11, 2019 (DE) 10 2019 205 205.3

(51) Int. Cl. G10L 15/22; H04R 1/40; H04R 3/00

(52) U.S. Cl. CPC G10L 15/22; G10L 2015/223; H04R 3/005; H04R 1/406

(57) ABSTRACT

An interaction device for use in a household contains a first microphone and a second microphone. Preferably, a polar pattern of the first microphone is configured for sampling in the close range, and a polar pattern of the second microphone is configured for sampling in the far range. The interaction device further has a processing unit configured to ascertain a verbal instruction on the basis of samplings performed by the microphones, and execute a control operation associated with the instruction.

The invention relates to an interaction facility. In particular, the invention relates to an interaction facility for controlling a household appliance.

Various household appliances can be used in one household, for example a dishwasher, a cooker or an extractor hood. One or more of the household appliances can be controlled by means of an interaction facility. The interaction facility can be configured so as to identify a spoken instruction and to control an assigned function of one of the household appliances.

US 2017 361 468 B2 describes a mobile interaction facility that can be attached to various household appliances.

Such an interaction facility is however not suitable for all actual application cases. For example, a distance from which a spoken instruction is accepted is usually limited. Interaction facilities are thus usually relatively expensive and inflexible.

An object that forms the basis of the present invention is to propose a technique that renders possible better interaction with a human. The invention achieves this object by means of the subject matters of the independent claims. Dependent claims disclose preferred embodiments.

An interaction facility for use in a household comprises a first and a second microphone that are configured so as to acoustically scan a predetermined area of a household; and a processing facility that is configured so as on the basis of scanning the microphones to identify a spoken instruction and to implement a control that is assigned to the instruction.

It is possible by using two microphones for the interaction facility to be addressed more efficiently from an expanded distance range. It is possible by exploiting conventional sensitivities of suitable microphones for the interaction facility to be addressed from a range the size of which corresponds to a conventional apartment or a conventional room of an apartment or home.

In particular, the control can relate to a household appliance. It is preferred that a function of the household appliance is triggered or an operating parameter of the household appliance is provided or changed on account of the spoken instruction. The household appliance can comprise for example a cooker, a refrigerator, an extractor hood or an oven. In a further embodiment, the control relates to a function of the interaction facility itself, for example if the interaction facility displays step-by-step a recipe, provides information in response to a spoken question or creates a telephone connection to a predetermined participant. The interaction facility can be used as an interface between the human and any number of devices or information storage devices.

In a preferred embodiment, a directional characteristic of the first microphone is oriented so as to perform an acoustic scan in the close range and a directional characteristic of the second microphone is oriented so as to perform an acoustic scan in the long range of the interaction facility. It is possible by configuring the two microphones differently, to acoustically scan the area more efficiently. In particular, a sound source in the close range can be preferably scanned by means of the first microphone and a sound source in the long range can be preferably scanned by means of the second microphone. Undesired sound sources in the respective other range can be suppressed more efficiently.

The directional characteristic of the first microphone can be, for example, a relatively circular or spherical shape and the directional characteristic of the second microphone can be relatively heart-shaped or kidney-shaped. In other words, a directional efficiency of the second microphone is greater than that of the first microphone. The first microphone can be more sensitive with respect to a sound source in the close range, whereas the second microphone can more efficiently detect sound from a sound source that is arranged in the long range while suppressing interference noises. As a consequence, sound sources can be scanned more efficiently at different distances and differentiated from one another. The addressability of the interaction facility within a household can be improved.

It is preferred that multiple second microphones are provided that have directional characteristics that extend in different directions. The directions can extend in particular radially in a horizontal plane. This renders it possible to evaluate more efficiently respectively the signals from the particular microphone that has directional characteristics that are the closest to the sound source in the long range. Interferences that arrive at the interaction facility from slightly different directions can be rejected or suppressed more efficiently.

Moreover, the interaction facility can comprise an interface for connecting a mobile device to an input apparatus and an output apparatus. The term ‘connection’ can be understood in this context for example to be a communicative connection. Acoustic signals that are received by the interaction facility can therefore be processed by the mobile device. Conversely, it is naturally also possible that the mobile device will perform a voice output that is then output via a loudspeaker of the interaction facility. The mobile device can include in particular a personal digital assistant (PDA), a mobile telephone, a smart phone or a tablet computer. It is possible to run on the mobile device an application that realizes an interaction with a user. In this case, the interaction can make use of the input apparatus and/or output apparatus in the mobile device. In addition, one of the first or second microphones can be used for the interaction.

In a particularly preferred embodiment, it is determined on the basis of the first and the second microphone that a user has spoken a predefined code instruction, and subsequently an interaction is controlled by means of the mobile device. In other words, the interaction facility can be “woken up” from an idle state by means of the first and the second microphone. In this case, any instruction can be predefined for the wake-up call. It is thus possible to avoid said wake-up call being limited to a predefined spoken instruction of the mobile device—for example “Hey Siri” or “Alexa”. The instruction for the wake-up call can be predefined or selected by a user. The wake-up call can be performed rapidly and efficiently by means of local processing resources. A subsequent voice control can be performed in a known manner by means of a service in a cloud.

Furthermore, it is possible to provide a mounting facility for the mobile device. The mobile device can be attached mechanically to the mounting facility. In so doing, it is possible to produce a wireless or wired data interface and/or a wireless or wired energy interface between the mobile device and the interaction facility.

Furthermore, the interaction facility can comprise an energy supply for the mobile device. In one variant, the interaction facility can have a power supply unit for connecting to an electrical energy supply network. In a second variant that can be combined with the first variant, the interaction facility comprises a transportable energy storage device, in particular a rechargeable battery or a battery by means of which the interaction facility and/or the mobile device can be operated and/or recharged.

The interaction facility can comprise multiple elements that can be placed or attached in different sequences vertically one on top of the other. It is thus possible to create a modular interaction facility or a modular interaction system that can be configured differently in the vertical direction. It is preferred that while joining two elements together a data connection and/or an energy connection are produced in each case between said elements. The elements can be embodied in an essentially cylindrical manner with the result that multiple elements that are placed one on top of the other can in turn essentially produce a cylinder.

In some embodiments, the interaction facility has sealing means, such as for example sealing rings in order to protect the interaction facility against spray water and standing water on the standing surface. In this manner, the electronics in the interaction facility are protected against moisture.

The processing facility can be configured so as to determine the direction of a source of the spoken instruction. This can be performed in particular on the basis of phase shifts between signals from the two differently oriented microphones. It is possible by means of processing signals from multiple microphones to reduce the influence of another sound source. Furthermore, it is possible on the basis of signals from the microphones to determine or at least to estimate a distance of the source of the spoken instruction. Optionally, a position of the source of the spoken instruction can be determined with regard to the interaction facility and further optionally a plausibility check can be performed on the position with regard to a delimitation of a surrounding area. If the position is implausible, then the determined source can be rejected and another source can be determined for the spoken instruction.

In a further embodiment, the interaction facility comprises an acoustic output apparatus, an optical output apparatus and/or an optical input facility. The acoustic output apparatus can comprise in particular at least one loudspeaker, the optical output apparatus can comprise in particular a display or a projector and the optical input apparatus can comprise in particular a virtual keyboard. A virtual keyboard can comprise a projection facility for projecting predefined regions on a surface and a scanning facility for determining the position of an object, in particular a hand or a finger with regard to the projection.

According to a further aspect of the invention, an interaction system comprises an interaction facility that is described herein and a rotation facility. In this case, the processing facility is configured so as to rotate at least one of the input or output apparatuses and/or at least one of the microphones by means of the rotation facility into the determined direction of the source of the spoken instruction. The rotation facility can on the one hand facilitate or improve an exchange of information from or to the user. On the other hand, said rotation facility can provide the user with the improved impression that the interaction facility is facing said user with the result that said rotation facility can count on the attention of the said user. The rotational movement can be part of an interaction concept that uses for example a mimic of an illustrated face as an output means. In one embodiment, the interaction apparatus is configured so as to input and/or output empathetic or emotional signals in order to support or improve an interaction with the user. The rotational movement is preferably transmitted to an element that performs an optical output for the user. This can relate for example to a projector or a display apparatus of the mobile device or of the interaction facility. Features or advantages of the system can be transferred to the apparatus and conversely.

By virtue of the modular connectivity, a user is able to arrange elements of the interaction facility in such a manner that only the elements that the user wishes to rotate are rotated. For example, a virtual keyboard can also be rotated if there is sufficient space on a surface around the interaction facility for the projection of the keyboard. Otherwise, the virtual keyboard can be projected in a predefined, unchangeable direction. In the first case, one element that represents the virtual keyboard is arranged above the rotation facility and in the second case below said rotation facility.

According to a further aspect of the invention, in order to control an appliance in a household the method comprises steps for scanning sound by means of multiple microphones; determining a spoken instruction on the basis of scanning the microphones; and implementing a control that is assigned to the instruction. The method can render it possible for an interaction facility to be addressed by a user from an expanded range.

The method can be configured so as to run completely or in part on an apparatus that is described herein or on a system that is described herein. For this purpose, the apparatus or the system can comprise in particular a programmable microcomputer or microcontroller and the method can be in the form of a computer program product having program code means. The computer program product can also be stored on a computer-readable data carrier. Features or advantages of the method can be transferred to the apparatus or the system or conversely.

The invention described here can then in particular be advantageous if a user already owns a mobile device such as a smart phone or a tablet PC. These devices are mostly quite expensive and age quickly, but are relatively powerful. An average user would quite readily also enjoy using these devices for cooking in that the average user displays recipe steps on these devices. However, in this case, different problems arise: the microphones on smart phones are for good reason configured so that they preferably receive acoustic signals from the immediate environment but they are less sensitive for voice inputs from a distance. Furthermore, when cooking, the user frequently has wet or dirty fingers with the result that the user does not wish to touch the device. In addition, it can always occur that liquids are present on the standing surface or are sprayed thereon. Since the user frequently moves around when cooking, it is possible that the user cannot easily see the screen of the mobile device from all positions.

The interaction facility described herein can now make a contribution to solving these problems. Said interaction facility can be optimized in order to be able to easily understand voice instructions even from a distance. Said interaction facility can provide a mounting facility for the mobile device with the result that the user can easily see the screen at any time. For this purpose, the user can be located and the screen rotated accordingly. Furthermore, a specific distance between the mobile device and the standing surface can be realized in order to protect the mobile device against moisture. The interaction facility does not require in this case an expensive processor because it is possible to use the processor of the mobile device. In this manner, the interaction facility supplements the mobile device in a purposeful manner with the characteristics that make said mobile device particularly suitable for supporting a cooking procedure in the kitchen.

The invention is now further described with reference to the attached figures, in which:

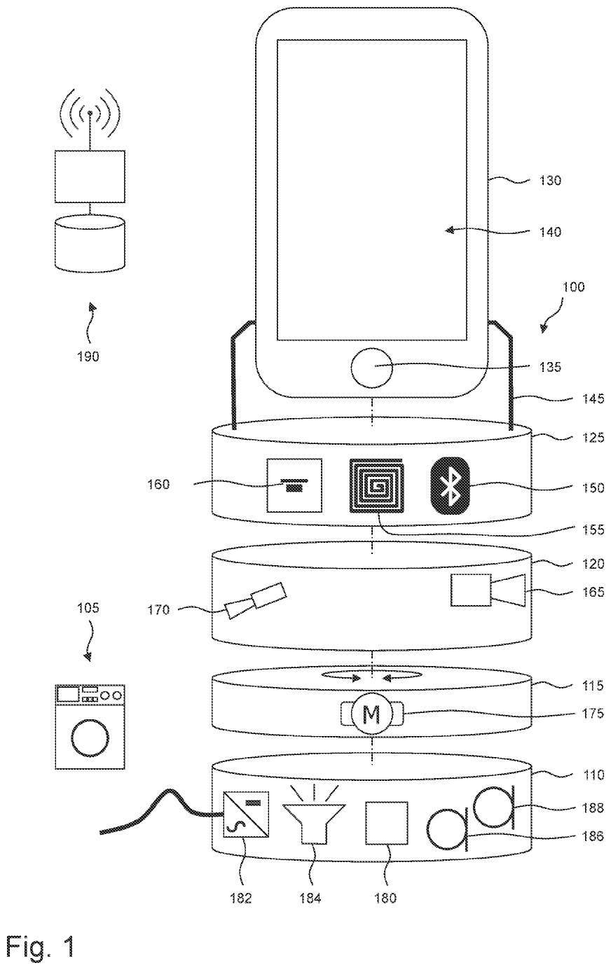

FIG. 1 shows an exemplary interaction system;

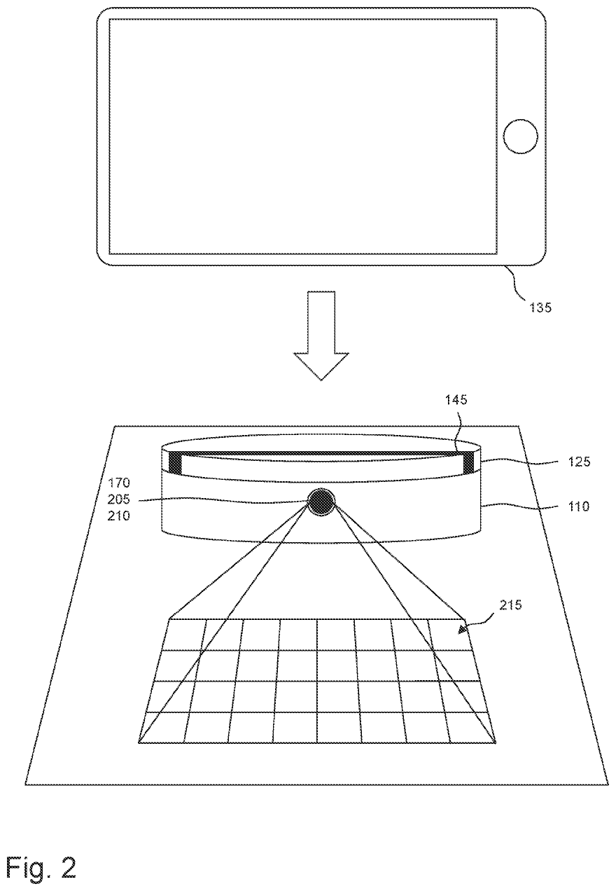

FIG. 2 shows an interaction facility in a further embodiment;

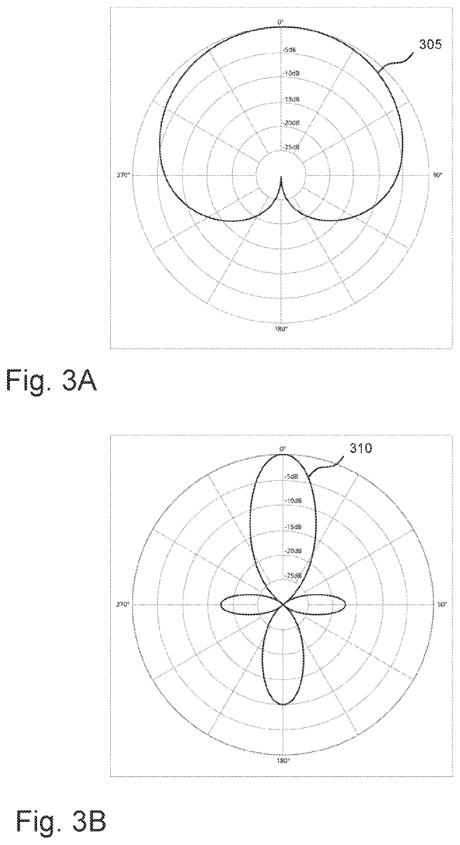

FIG. 3 shows exemplary directional characteristics of microphones; and

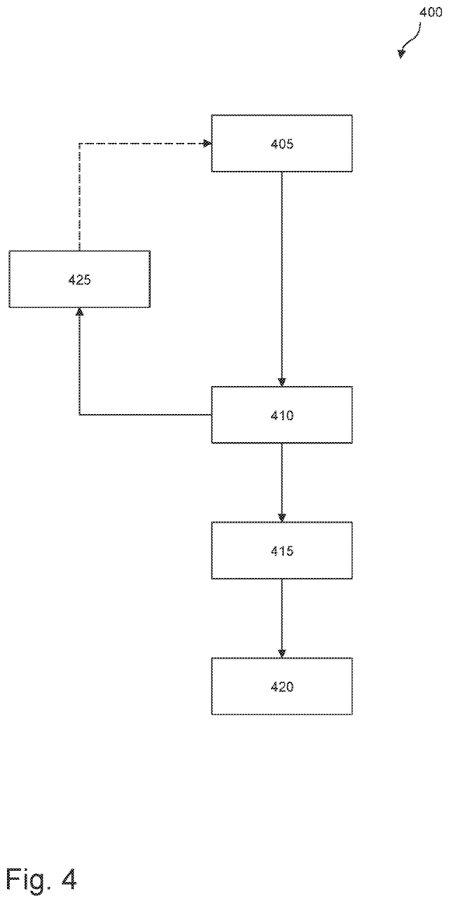

FIG. 4 shows a flow diagram of an exemplary method.

FIG. 1 illustrates an interaction system 100 that is configured for use in a household, in an illustration of a type of exploded drawing. The interaction system 100 is configured so as in response to an instruction spoken by a person to implement a control that is assigned to the instruction, said control relating in particular to a household appliance 105 and can comprise in particular performing an appliance-appropriate function. The interaction system 100 is preferably configured for use in a household and is preferably set up in an area of the household that is acoustically connected, for example in a kitchen, a combined kitchen/living room or an open plan living area that adjoins a kitchen area.

The interaction system 100 is preferably constructed in a modular manner and comprises an interaction facility 110 that can be expanded by one or multiple elements 115-125. The interaction facility 110 is considered below as required also as an element; moreover the interaction facility 110 can comprise one or multiple elements 115-125. Each element 110-125 is configured so as to fulfill one or multiple functions, wherein it is possible to select an assignment of functions to the elements 110-125 that is different to that in the present example. Accordingly a function component that is required for a function can also be arranged in or on another element 110-125 that is illustrated in FIG. 1. The elements 110-125 can preferably be stacked one on top of the other in the illustrated manner. In this case, a data interface and/or energy interface can be produced in each case between adjacent elements 110-125, for example by means of a plug-in contact. It is preferred that the elements 110-125 are each essentially in the form of a straight circular cylinder and the interaction system 100 has a matching shape. For this purpose, it is particularly preferred that the diameters of the elements 110-125 are identical. It is further preferred that a series of elements 110-125 can be varied. However, it is preferred that the lowest element comprises the interaction facility 110.

The uppermost element 125 is preferably configured so as to attach a mobile device 130 that has at least one input facility 135 and/or at least one output apparatus 140. The input apparatus 135 can have in particular a microphone, a camera or a touchscreen. The output apparatus 140 can comprise in particular a display apparatus, preferably as part of a touchscreen, a loudspeaker or an illuminating facility. In order to attach the mobile device 130 to the uppermost element 125, it is possible to provide a mounting facility 145 that in the present case is embodied by way of example in the form of a retaining bracket or a holding plate. A data connection between the uppermost element 125 and the mobile device 130 can be produced by means of a data interface 150 that is preferably embodied in a wireless manner, for example as a Bluetooth or a wireless local area network (WLAN) connection. Energy can be exchanged between the module 125 and the mobile device 130 by means of an energy interface 155 that is preferably embodied likewise in a wireless manner, in particular by means of inductive energy transfer, for example according to the Qi standard. For this purpose, the energy interface 155 can be integrated in the mounting facility 145 in order to lie as close as possible to a reception coil of the mobile device 130. The data interface 150 and/or the energy interface 155 can each also be embodied in a wired manner, for example as a USB plug-in connection. The element 125 can comprise an energy storage device 160 with the result that it can be used to operate or recharge the mobile device 130, without itself being in physical contact with the other elements 110-120.

The element 120 can comprise a projector 165 that is preferably configured so as to project a graphic or textual illustration onto a surface. In this case, the projector 165 can be configured in particular for projecting onto a horizontal surface, such as a work surface, or onto a vertical surface, such as a wall or furniture. Moreover, the element 120 can comprise a virtual keyboard 170 that is further described below with reference to FIG. 2.

The element 115 comprises preferably a rotation facility 175 that is configured so as to change an angle of rotation about a vertical axis with regard to an element 110, 120, 125 that is lying above or below. The rotation facility 175 can comprise for this purpose in particular an electric motor or an ultrasound motor. It is possible by means of the element 115 for elements 120, 125 that are preferably attached above and where appropriate the mobile device 130 to be rotated about the vertical axis with respect to an element 110 that is attached below or a sub-base.

It is preferred that the element 110 comprises a processing facility 180 and an energy supply 182 that preferably comprises a power supply part for connecting to an energy supply network. Optionally, an acoustic output apparatus 184 is provided, in particular in the form of a loudspeaker. Moreover, at least a first microphone 186 and at least a second microphone 188 are provided. Multiple first and/or second microphones 186, 188 can be oriented in different directions in order in each case to scan preferably sound from the respective direction. The multiple first and/or second microphones 186, 188 can also be attached to different sites of the interaction system 100, for example to a periphery about the vertical axis. The processing facility 180 is preferably configured so as to analyze signals from the microphones 186, 188. Moreover, the processing facility 180 is to be configured so as to determine a spoken instruction on the basis of the signals and further preferably to implement or perform a control that is assigned to the instruction. The control can relate in particular to a household appliance 105 that can be located in the same household.

In this case, the control signals can be transmitted directly or via an external entity 192 that can be connected to the processing facility 180 by means of an in particular wireless data interface. The external entity 192 can also perform part of the processing or the entire processing of the signals that are supplied by the microphones 186, 188. The external entity 192 can be realized as a server or service, in particular in a cloud. In a further embodiment, the control relates to the external entity 192 and can comprise for example querying or changing information.

FIG. 2 illustrates an exemplary interaction system 100 in a further embodiment. The mobile device 130 in this case is embodied by way of example as a tablet computer and the interaction system 100 comprises only the first element 120 and the third element 125. The mounting facility 145 is embodied as a groove on the third element 135 and the mobile device 130 can be inserted in part into said groove. The first element 120 comprises the virtual keyboard 170 that preferably comprises a projection facility 205 for projecting an illustration onto a surface and a scanning facility 210 for scanning an object in the region of the illustration. It is preferred that the illustration comprises at least one field 215 and the object can comprise in particular a finger or a hand of a user. Multiple illustrated fields 215 can have a predefined arrangement and can form for example a keyboard. The scanning facility 210 that can be embodied for example as an infrared camera can detect that the object is touching one of the fields 215.

FIG. 3 illustrates by way of example directional characteristics of microphones 186, 188. FIG. 3a illustrates a heart-shaped first directional characteristic 305 that can be assigned to a first microphone 186 and FIG. 3b illustrates a super cardioid or figure-eight shaped second directional characteristic 310 that can be assigned to a second microphone 188. Both illustrations are polar and illustrate a sensitivity of the microphones 186, 188 as a distance from a central point (a large distance corresponds to a high degree of sensitivity and conversely), in dependence upon a direction from which the sound is acting on the microphone 199, 188. The microphone 186, 188 is oriented in each case in the direction θ° and is most sensitive to sound from this direction.

The first directional characteristic 305 demonstrates a, to some extent, constant sensitivity of the first microphone 186 in a front semi-circle between 270° and 90°. Sound from directions that lie on a rear semi-circle, in other words the region from 270° above 180° towards 90° can be suppressed for example by means of an attenuating element such as foam or wadding.

The second directional characteristic 310 demonstrates a strong focus on sound from the direction θ°. A further preferred direction extends in the direction 180°, wherein preferably sound from the rear semi-circle is attenuated. Two further, weaker sensitivity lobes extend perpendicular thereto in 270° and 90° directions. Sound from these directions can be recognized in either an attenuated or processing manner.

The directional characteristics 305, 310 demonstrate that the first microphone 186 is configured in a suitable manner so as to detect sound from a close range, whereas the second microphone 188 is configured in a suitable manner so as to detect sound from a long range. In order to scan a sound source in an optimum manner, a microphone 186, 188 can be rotated in such a manner that its 0° direction faces the sound source. If multiple differently oriented microphones 186, 188 are provided, then it is possible to preferably evaluate signals from the particular microphone 186, 188 that is oriented most efficiently in the direction of the sound source. The position of a sound source with regard to the microphone 186, 188 can be determined by considering phase shifts and/or amplitudes of signals from different microphones 186, 188, wherein the signals relate to sound from the same sound source.

Different directional characteristics to the illustrated directional characteristics 305, 310 are likewise possible, wherein the first directional characteristic 305 of the first microphone 186 is preferably broader with regard to its directional spectrum than the second directional characteristic 310 of the second microphone 188. For example, the first directional characteristic 305 can have a circular shape and the second directional characteristic 310 can also be purely kidney-shaped.

FIG. 4 illustrates a flow diagram by way of example of a method 400 that can be performed by means of an interaction system 100. In one step 405, sound from a sound source can be detected by means of the microphones 186, 188. For this purpose, signals from multiple first and/or second microphones 186, 188 are provided that preferably relate to the same sound source. All other signals can be considered as interference signals. In a step 410, the signals are processed. In this case, a direction is determined from which the sound arrives at the interaction facility 110. Moreover, in order to improve a useful signal, it is possible to free a signal about interference signals. Optionally, a position of the sound source is determined. If the determined position transpires to be unrealistic, then a further processing can be omitted or can be repeated with different parameters or assumptions.

On the basis of the useful signal, a spoken instruction is identified in a step 415. If the sound that has produced the signals that are provided by the microphones 186, 188 does not correspond to a spoken instruction, then further processing can be suspended. If it concerns a spoken instruction that is not assigned to a known function or control, then a corresponding message can be output to the speaker of the instruction. Otherwise, the control can be determined that is assigned to the spoken instruction. This instruction can be implemented in a step 420. For example, in this step a parameter of a household appliance 105 can be changed or a function of the household appliance 105 can be triggered.

On the basis of the direction determination that is performed in the step 410, it is possible in a step 425 to use the rotation facility 175 for the purpose of rotating at least one part of the interaction system 100. The rotation is preferably performed in such a manner that an input facility 135, 170, 186, 188 and/or an output facility 140, 165, 184, 170 is oriented in the direction of the sound source. The sound source usually includes a user and the rotation can render possible an improved interaction with the user. In a different embodiment, the user can also be located in a different manner, for example by means of a camera.

### LIST OF REFERENCE NUMERALS

100 Interaction system
105 Household appliance
110 Interaction facility
115 First element
120 Second element
125 Third element
130 Mobile device
135 Input apparatus
140 Output apparatus
145 Mounting facility
150 Data interface
155 Energy interface
160 Energy storage device
165 Projector
170 Virtual keyboard
175 Rotation facility
180 Processing facility
182 Energy supply
184 Loudspeaker
186 First microphone
188 Second microphone
190 External entity
205 Projector
210 Scanning facility
215 Field
305 First directional characteristic
310 Second directional characteristic
400 Method
405 Detect sound
410 Locate sound
415 Identify instruction
420 Implement instruction
425 Rotate interaction facility

1-11. (canceled)

12. An interaction facility for use in a household, the interaction facility comprising:
microphones, including a first microphone and a second microphone, being configured so as to acoustically scan a predetermined area of the household; and
a processor configured so as on a basis of scanning said microphones to identify a spoken instruction and for implementing a control being assigned to the spoken instruction.

13. The interaction facility according to claim 12, wherein a directional characteristic of said first microphone is oriented so as to perform an acoustic scan in close range and a directional characteristic of said second microphone is oriented so as to perform an acoustic scan in a long range of the interaction facility.

14. The interaction facility according to claim 13, wherein said second microphone is one of a plurality of second microphones having directional characteristics that extend in different directions.

15. The interaction facility according to claim 12, further comprising an interface for connecting a mobile device to an input apparatus and/or an output apparatus.

16. The interaction facility according to claim 15, further comprising a mounting facility for the mobile device.

17. The interaction facility according to claim 15, further comprising an energy supply for the mobile device.

18. The interaction facility according to claim 12, further comprising a plurality of elements that can be placed in different sequences vertically one on top of another.

19. The interaction facility according to claim 12, wherein said processor is configured to determine a direction of a source of the spoken instruction.

20. The interaction facility according to claim 12, further comprising an acoustic output apparatus, an optical output apparatus and/or an optical input facility.

21. An interaction system, comprising:
an interaction facility for use in a household, said interaction facility containing:
microphones, including a first microphone and a second microphone, being configured to acoustically scan a predetermined area of the household; and
a processor configured so as on a basis of scanning said microphones to identify a spoken instruction and for implementing a control being assigned to the spoken instruction, wherein said processor being configured to determine a direction of a source of the spoken instruction;
apparatuses including an input apparatus and an output apparatus; and
a rotation facility, said processor configured to rotate at least one of said apparatuses and/or at least one of said microphones by means of said rotation facility into the direction of the source of the spoken instruction.

22. A method for controlling an appliance in a household, which method comprises the steps of:
scanning for sound by means of a plurality of microphones;
determining a spoken instruction on a basis of scanning the microphones; and
implementing a control that is assigned to the spoken instruction.
